(19) United States
(12) Patent Application Publication
(10) Pub. No.: US 2003/0032410 A1
(43) Pub. Date: Feb. 13, 2003

(54) Multi-modal directories for telephonic applications

(75) Inventor: Vijay Anand Saraswat, Mountain Lakes, NJ (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kirusa, Inc.

(21) Appl. No.: 10/211,070

(22) Filed: Aug. 2, 2002

Related U.S. Application Data
(60) Provisional application No. 60/310,615, filed on Aug. 7, 2001.

(51) Int. Cl. H04Q 7/20; H04M 11/00; H04M 3/42

(52) U.S. Cl. 455/414; 455/403

(57) ABSTRACT

A technique for providing multi-modal interaction with a directory. A user of a telephone set connects to a directory service, such as a directory assistance service that provides telephone numbers. The user interacts with the system, either by engaging in voice communications with a human operator, or by interacting with an automated system that employs voice recognition. The directory service then provides the requested information (e.g., a requested telephone number) to the user in the form of data that can be captured and used by the telephone—e.g., if the requested information is a telephone number, the telephone may store the data representation of that number in a contacts list, or place a call to the number without the user having to enter the number with a keypad.

### CROSS-REFERENCE TO RELATED APPLICATIONS

This application claims the benefit of U.S. Provisional application No. 60/310,615, entitled “Multi-Modal Directories for Telephonic Applications,” filed Aug. 7, 2001.

### FIELD OF THE INVENTION

The present invention relates generally to the field of telephony. More particularly, the invention provides a technique for interacting with a directory in a multi-modal manner. In one example, the directory (e.g., a telephone directory such as a 411 service) may be queried using a wireless telephone's voice mode, and the response to the query may be provided in the wireless telephone's visual/data mode so that the query response can be captured in a useful form, such as a contacts list.

### BACKGROUND OF THE INVENTION

As computer technology becomes more widely available, the transmission of voice information has become increasingly intertwined with the transmission of data. Traditionally, a telephone captures audio for transmission to another party, and renders audio signals received from another party. Today's telephone (including both wired and wireless telephones) have at least some data handling and processing capability. Thus, such telephone can generate certain types of data for transmission to other parties, and can process certain non-audio data received from other parties. One example of this is a telephone set with a built-in caller-ID feature, in that such a telephone handles both audio (i.e., the voice of the calling party) and data (i.e., the caller-ID information that identifies the calling party).

While voice and data each have advantages in certain contexts, many uses of a telephone require the user to perform certain tasks using voice and other tasks using data. One case in point is a directory service such as “411.” In a typical directory service, a caller uses a telephone's voice mode to ask a human operator to lookup a telephone number, and then receives the telephone number in the form of voice (although that voice may be machine-synthesized). However, in order to use the number to place a call, the user will have to re-enter that number as data. It would be more useful to the caller if the numeric data itself were transmitted to the telephone. Some directory services provide the feature of completing the call for the user (i.e., without the user having to listen to the number and enter it on the keypad), but these features do not provide the number to the telephone set in the form of usable data.

In view of the foregoing, there is a need for a directory query-response technique that overcomes the drawbacks of the prior art.

### SUMMARY OF THE INVENTION

The present invention provides a system and method whereby a directory may be queried using a telephone set, wherein the response to the query is provided to the user in a useful data form. For example, a user of the telephone set may dial a telephone directory service such as “411,” although it will be understood that a directory of telephone numbers is a non-limiting example. In this example, the user requests the telephone number of a particular party (e.g., a person, a business, etc.) by speaking the name of that person or business into the telephone set. The user's speech may be received either by a human operator, or by an automated directory system equipped with voice recognition. The directory service provides the requested telephone number to the user in the form of data. This data may, in one example, be a Wireless Markup Language (WML) page containing the telephone number. By providing the data in this form, the user may, for example, enter the telephone number into a personal contacts list, or dial the number without having to re-enter it on the keypad.

Other features of the invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of a telephone network architecture in which aspects of the invention may be implemented; and

FIG. 2 is a flow diagram of an exemplary process for requesting directory assistance in accordance with aspects of the invention.

### DETAILED DESCRIPTION OF THE INVENTION

The present invention provides a system and method whereby a directory may be queried using a telephone set, wherein the response to the query is provided to the user in a useful data form. One problem with existing voice directory services (e.g., the “411” telephone directory assistance service) is that the number is provided to the requesting user's telephone in the form of speech (i.e., human or synthesized voice speaking the requested number), and in order for the number to be used it must be in the form of data. Thus, a user must hear the requested information and then enter it using a keypad. This problem is equally present in other types of voice directories (e.g., an Internet directory, where a user may have to listen to a Universal Record Locator (URL) in the form of speech and then re-enter it into a browser by hand in order to navigate to the URL). The present invention provides the response to a directory query in the form of data so that the responsive information may be conveniently entered into a contacts list, or used to dial a telephone number.

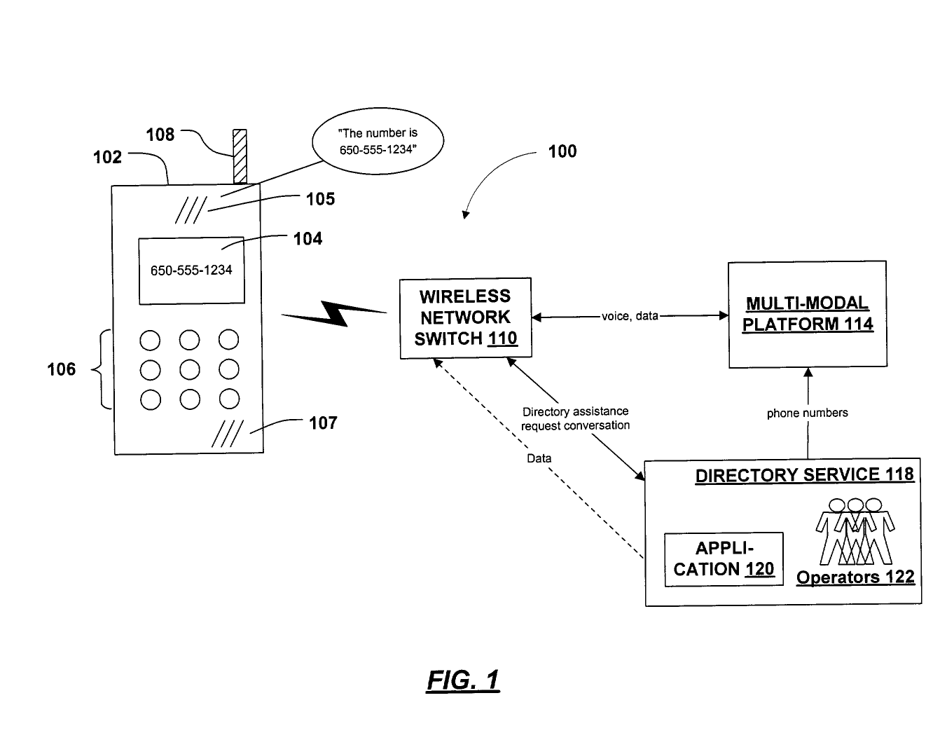

FIG. 1 shows a telephone network architecture 100. Architecture 100 includes a wireless telephone 102, a wireless network switch 110, a multi-modal platform 114, and an exemplary directory service 118. While architecture 100 is shown, for exemplary purposes only, in the context of wireless telephony, it will be appreciated that the invention applies to any type of telephony or communications architecture including (but not limited to) wired telephony.

In a preferred embodiment, wireless telephone 102 comprises a visual display 104, an audio speaker 105, a keypad 106, a microphone 107, and an antenna 108. Visual display 104 may, for example, be a Liquid Crystal Display (LCD) which displays text and graphics. Audio speaker 105 renders audio signals (e.g., signals received from other components in architecture 100) in order to produce audible sound. Keypad 106 may be an alpha-numeric keypad that allows a user to input alphanumeric characters. Depending upon context, wireless telephone may respond to input from keypad 106 by displaying appropriate characters on display 104, transmitting ASCII representations of such characters, or (in the case of numeric input) generating appropriate Dual Tone Multi-Frequency (DTMF) signals. Microphone 107 captures audio signals, which may, in one example, be digitally sampled by wireless telephone 102 for wireless transmission to other components of network architecture 100. Antenna 108 is used by wireless telephone 102 to transmit information to, and receive information from, components within architecture 100. For example, wireless telephone 102 may use antenna 108 to receive digital audio signals for rendering on speaker 105, to transmit digital audio signals captured by microphone 107, to receive data to be displayed on visual display 104, or to transmit data captured by keypad 106. Wireless telephone 102 may also contain computing components (not shown). For example, wireless telephone 102 may have a memory and a processor, which may be used to store and execute software (e.g., software that digitally samples audio signals captured with microphone 107, software that generates analog audio signals from digitally-sampled audio received through antenna 108, software that enables the browsing of content using visual display 104 and keypad 106, etc.). The structure of a wireless telephone 102 that employs the components shown in FIG. 1 in connection with a memory and processor will be apparent to those of skill in the art, and thus is not discussed at length herein.

One feature of wireless telephone 102 is that it can be viewed as having two different “modes” of communication. On the one hand, wireless telephone 102 communicates in a “voice” mode; on the other hand, wireless telephone 102 communicates in a “visual” mode. In voice mode, wireless telephone uses microphone to capture audio (which may be digitally sampled and then transmitted through antenna 108), and uses speaker to render audio (which may be received through antenna 108 in a digital form). “Voice” mode is exemplified by the conventional usage of a telephone in which a first party uses the telephone to engage in two-way speech with another party. In “visual” mode, wireless telephone uses keypad 106 to capture data (e.g., alpha-numeric data which may be represented in ASCII form), and uses visual display 104 to render data. The captured data may be transmitted through antenna 108, and antenna 108 may also be used to receive the data that is to be displayed on visual display 104.

Wireless telephone 102 communicates with a wireless network switch 110. Wireless network switch is coupled to a tower (not shown) that engages in two-way communication with wireless telephone 102 through antenna 108. Wireless network switch 110 connects wireless telephone 102 to various components, such as multi-modal platform 114, and directory service 118. Directory service may, in one example, be located on a Public Switched Telephone Network (PSTN) (not shown), which is known in the art and is not described herein.

In accordance with aspects of the invention, multi-modal platform 114 may facilitate communication with wireless telephone 102 in two “modes” (i.e., in voice mode and visual mode). For example, multi-modal platform 114 may be adapted to send audio information to and receive audio information from wireless telephone 102 through switch 110 using a voice channel. Multi-modal platform 114 may likewise be adapted to send visual data to and receive visual data from wireless telephone 102 through switch 110 using a data channel. Moreover, multi-modal platform 114 may be adapted to change between these two “modes” of communicating according to instructions or existing communications conditions. Multi-modal platform 114 may be embodied as a computing device programmed with instructions to perform these functions.

Directory service 118, in a generalized form, is a service that receives a request and provides information in response to that request. For example, directory service 118 may be a “411” service that looks-up and provides telephone number. As another example, directory service 118 may be an “Internet directory” that looks-up and provides URLs in response to user requests. It will be understood that these are merely examples of a directory service 118 and are not limiting of the invention.

Directory service 118 may be embodied as any means that receives a request and provides information in response to the request. As one example, directory service 118 may be company that employs human operators 122 who receive phone calls from a telephone users (e.g., a user of telephone 102), and provide information to such users based on a conversation with those users. In another example, directory service is a computing device that executes directory application software 120, where the application software 120 receives a request from the user of a telephone (e.g., using a voice recognition system), automatically obtains the information (e.g., using a search engine, database, etc.), and provides the information to the user (e.g., using a voice synthesis system). In yet another example, directory service may be some hybrid of these two examples—e.g., a service that uses human operators 122 to engage in a conversation, but that uses a computing device and a software application 120 to provide at least some part of the lookup or output. (One example of such a “hybrid” is a directory service wherein a human operator receives the lookup request through a voice conversation, but then uses a computer to provide a voice-synthesized response to the requester.)

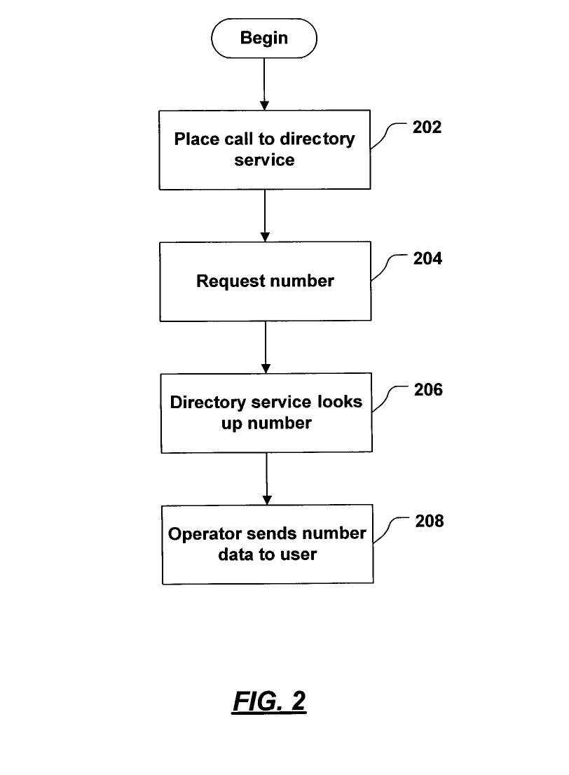

An exemplary process of using a directory is described below with reference to FIGS. 1 and 2. In accordance with the invention, a user of telephone 102 uses directory service 122 by placing a call to directory service 122 (FIG. 2, block 202). For example, a user of telephone 102 may dial “411” in order to obtain directory assistance. The user may then engage in a conversation with operators 122 using speaker 105 and microphone 107 (block 204). As one example, the user may say to the operator: “I'd like the number of Joe's Pizza.” The operator 122 may then look-up the number of “Joe's Pizza” (block 206) (e.g., using a computer present at directory service 118), at which point the number of “Joe's Pizza” appears on a computer screen in front of operator 122. Operator 122 may then speak the number to the requestor, who may receive it through speaker 105, as shown in FIG. 1. In addition to speaking the telephone number (or in the alternative to speaking the telephone number), operator 122 may send the data representation of the telephone number to telephone 102 (block 208). This may occur, for example, by sending the telephone number to multi-modal platform 114, which negotiates the communication of this telephone-number data to telephone 102 (which may be necessary since telephone 102 is already involved in a voice call, and many telephone networks are adapted to communicate in either voice mode or data mode, but not both simultaneously). Alternatively, operator 122 may send the telephone number directly to switch 110 for dispatch to telephone 102 (which may be possible if switch 110 is adapted to negotiate multi-modal communication with wireless telephone 102). The data that embodies the telephone number may, as one example, be in the form of a Wireless Markup Language (WML) page, although it will be understood that other types of data representations may be used without departing from the spirit and scope of the invention. Once the telephone number (or other type of response) is available on telephone 102 in the form of data, the user of telephone 102 may store this number (e.g., in the form of a contact in telephone 102 or on multi-modal platform 114, in a personal persistent directory store), or may use the number to place a call.

While the foregoing examples have been provided in the context of wireless telephony, it should be noted that the above-described system can also be deployed in any communications context, such as a wired telephone system. For example, wireless telephone switch 110 can be a wired-network telephone switch, such as a “5E,” and wireless telephone 102 may be embodied as an wired telephone that is enabled to receive both voice and data.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method of providing a directory service which receives a request and which provides information in response to the request, the method comprising:
receiving a request from a user of a telephone in an audio form;
looking up information responsive to said request;
providing said information to said telephone in a form of data capturable by said telephone.

2. The method of claim 1, wherein said request comprises a request for a telephone number, and wherein said information comprises said telephone number.

3. The method of claim 1, wherein said data capturable by said telephone comprises Wireless Markup Language (WML) data.

4. A method of obtaining directory assistance comprising:
using a telephone to place a voice call to a directory assistance service;
requesting directory information from said directory assistance service; and
receiving said directory information at said telephone in the form of non-voice data.

5. The method of claim 4, wherein said directory information comprises a telephone number.

6. The method of claim 4, wherein said telephone comprises a wireless telephone.

7. The method of claim 4, wherein said non-voice data comprises Wireless Markup Language (WML) data.

8. The method of claim 4, further comprising:
using said non-voice data to place a voice call to a party indicated by said directory information.

9. The method of claim 4, further comprising:
using said non-voice data to add said directory information to a contact list on said telephone.

10. In a communications device that allows a user to engage in a voice call with a directory service, the improvement comprising:
software that receives data indicative of a telephone number in response to a conversation that occurs between the user and the directory service during the voice call, and that places a voice call to said telephone number in response to a user-generated instruction.

11. The improvement of claim 10, further comprising:
software that adds the telephone number to a contacts list.
